(19) United States
(12) Patent Application Publication
(10) Pub. No.: US 2007/0165015 A1
(43) Pub. Date: Jul. 19, 2007

(54) Efficient use of synchronous dynamic random access memory

(75) Inventors: Huan-Hsin Li, Hsinchu (TW); Yu-Hsi Ho, Hsinchu (TW); Yao-Jen Hsieh, Hsinchu (TW)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: AU Optronics Corporation

(21) Appl. No.: 11/644,214

(22) Filed: Dec. 22, 2006

Related U.S. Application Data
(60) Provisional application No. 60/760,126, filed on Jan. 18, 2006.

(51) Int. Cl. G06F 3/038

(52) U.S. Cl. 345/204

(57) ABSTRACT

DDR_SDRAM chips running at 1.5 clock rate are used for transferring image data from an image data source to a source driver in a display panel. In general, P DDR_SDRAM chips running at a 1.5 clock rate are used to store frame data in N frames. If the frame date in each of the N frames is n bits and the memory space in the DDR_SDRAM chip is m, then P is a smallest integer equal to or greater than N multiplied by (n/m). In data transfer in a frame, a line period is partitioned into N segments and each DDR-SDRAM chip is separated into (N−1) parts such that the parts are used to read different data in the different frames. In order to share I/O pins when using a number of DDR_SDRAM chips, the read/write sequence for the all DDR_SDRAM chips follows the same command and address.

This patent application is based on and claims priority to U.S. patent application Ser. No. 60/760,126, filed Jan. 18, 2006, and assigned to the assignee of the present invention.

### FIELD OF THE INVENTION

The present invention relates generally to the use of a memory device for storing a plurality of data frames and, more specifically, to the use of synchronous dynamic random access memory for data storage.

### BACKGROUND OF THE INVENTION

Double Data Rate (DDR) synchronous dynamic random access memory (SDRAM) was defined in 1997 by the Joint Electronic Device Engineering Council (JEDEC), the semiconductor engineering standardization body of the Electronic Industry Alliance. DDR_SDRAM is designed to deliver twice the bandwidth of the older SDRAM. As known in the art, in SDRAM, one bit per clock cycle is transferred from the memory cell array to the input/output (I/O) buffer data queue (DQ). The I/O buffer releases one bit to the bus per pin per clock cycle on the rising edge of the clock signal. DDR_SDRAM uses both the rising and falling edges of the clock to trigger the data transfer to the bus. It uses a pre-fetching technique, known as double transition clocking, to deliver twice the bandwidth of SDRAM without increasing the clock frequency. DDR_SDRAM has theoretical peak transfer rates of 1.6 and 2.1 GB/s at clock frequencies of 100 MHz and 133 MHz, respectively.

SDRAM and DDR_SDRAM are commonly used as data storage devices in an image display device. For example, Champion (U.S. patent Publication No. 2002/010979 A1) discloses a method and apparatus for storing data, wherein two dimensional arrays are mapped to memory locations, and two memory devices are used in a buffer page system for a video scan converter. The two memory devices are two SDRAMs arranged in a frame buffer architecture such that pixel data for two pixels can be accessed in parallel. In particular, Champion uses two 32-bit wide 8 MB SDRAMs running at 150 MHz to support the data rate needed for a screen resolution such as HD (1920×1080) at 600 MB/s. Park (U.S. patent Publication No. 2005/0110750 A1) discloses an apparatus and method for signal processing in a liquid crystal display panel, wherein three frames of data are stored in one frame memory in DDR_SDRAM. FIG. 1 is a timing chart illustrating the read/write timing of a frame memory as disclosed in Park. FIG. 2 is a timing chart illustrating the read/write timing of a buffer as disclosed in Park.

In general, if one frame data (e.g. 1920×1200×3×10 bit=66 Mbit) is to be stored, one 4 M Word×32 bit (=128 Mbit) DDR_SDRAM with double read/write clock frequency would be sufficient. A timing chart for storing one frame data in one frame period using double clock rate is shown in FIG. 3. If two frame data are to be stored, two such DDR SDRAM chips are needed. However, because DDR_SDRAM uses a 2.5-V signal specification known as Stub Series Terminated Logic_{—}2 (SSTL_{—}2 associated with 0.25 μm fabrication process), the clock frequency is limited to 133 MHz which is much lower than two times of 85 MHz for 1920×1200 resolution. One way to get around this problem is to use three 4 M×32 bit DDR_SDRAM chips running at 1.5×85 MHz (=127.5 MHz). In order to access three frame data during one frame period, it may be necessary to use four 4 M×32 bit DDR_SDRAM chips.

Such usage of DDR_SDRAM is, however, not cost effective. Furthermore, a considerable number of I/O pins on the memory chips are wasteful because they are not used.

It is thus desirable and advantageous to provide a method to reduce the number of DDR_SDRAM chips and to minimize the number of unused I/O pins on the memory chips.

### SUMMARY OF THE INVENTION

The present invention uses DDR_SDRAM chips running at 1.5 clock rate so that the data transfer system is more stable than the higher 2.0 clock rate. The present invention also minimizes the number of DDR_SDRAM chips required for frame data transfer. In general, P DDR_SDRAM chips are used to store frame data in N frames using a different clock rate. If the frame date in each of the N frames is n bits and the memory space in the DDR_SDRAM chip is m, then P is an integer which is not smaller than the smallest integer equal to or greater than N multiplied by (n/m). For example, if n is 66 Mbits and m is 128 Mbits, then the smallest P is 2 when N=3. When N=4 or 5, the smallest P is 3, but P can be 4 or a larger integer. When P DDR_SDRAM chips are used to store frame data, a line period is partitioned into N segments and each DDR-SDRAM chip is separated into (N−1) parts such that the parts are used to read different data in the different frames.

The minimum number, P, varies with the size of frame data and the memory space of the DDR_SDRAM chips. In order to share I/O pins when using a number of DDR_SDRAM chips, the read/write sequence for the all DDR_SDRAM chips follows the same command and address.

Thus, the first aspect of the present invention is a method for transferring frame data in N frames, said N frames comprising a current frame and (N−1) previous frame. The method comprises:

providing P memory chips for reading or writing the frame data in a line period; and

separating each of the P memory chips into (N−1) parts so that each part is used to read a portion of frame data in a different one of the (N−1) previous frames and one part is used to write a portion of frame data in the current frame, wherein each of N frames has a data size of n bits and each of the P memory chips has a memory space of m bits, and wherein P is an integer greater than or equal to N multiplied by (n/m).

The method further comprises partitioning a line period in a frame of said N frames into N line period segments, so that reading of the portion of the frame data in each different one of the (N−1) previous frames and writing of the portion of frame data in the current frame are carried out in different line period segments, wherein the N line period segments include a last segment preceded by (N−1) segments, and wherein the reading is carried out in said (N−1) preceding segments and the writing is carried out in the last segment, and wherein the (N−1) preceding segments include a first segment and wherein the reading in the first segment and the writing in the last segment are carried out in a same part of the P memory chips.

According to the present invention, the memory chips comprise double data rate synchronous dynamic random access memory chips, wherein the frame data are stored in a plurality of buffer memory chips before transferring and the buffer memory chips have a data transfer clock rate. The method further comprises:

running the double data rate synchronous dynamic random access memory chips at a clock rate substantially equal to 1.5 times the data transfer clock rate of the buffer memory chips.

According to one embodiment of the present invention, the frame data comprises a front data part and a back data part. The method further comprises:

arranging at least one of the buffer memory chips for transferring the front data part to one of the double data rate synchronous dynamic random access memory chips; and

arranging at least another of the buffer memory chips for transferring the back data part to another of the double data rate synchronous dynamic random access memory chips.

According to the present invention, each of the front data part and the back data part comprises an odd data segment and an even data segment. The method further comprises:

arranging one of said at least one of the buffer memory chips for transferring the even data segment in the front data part to said one of the double data rate synchronous dynamic random access memory chips;

arranging another of said at least one of the buffer memory chips for transferring the odd data segment in the front data part to said one of the double data rate synchronous dynamic random access memory chips;

arranging one of said at least another of the buffer memory chips for transferring the even data segment in the back data part to said another of the double data rate synchronous dynamic random access memory chips; and

arranging another of said at least another of the buffer memory chips for transferring the odd data segment in the back data part to said another of the double data rate synchronous dynamic random access memory chips.

According to the present invention, the N frames include a current frame and two previous frames. The method further comprises:

arranging two different ones of the buffer memory chips for separately reading the front data in the previous frames from said one of the double data rate synchronous dynamic random access memory chips; arranging another two different ones of the buffer memory chips for separately reading the back data in the previous frames from said another of the double data rate synchronous dynamic random access memory chips; and

arranging a further group of buffer memory chips for transferring the front and back data parts in the current frame, bypassing the double data rate synchronous dynamic random access memory chips.

The second aspect of the present invention is a method for transferring image data from an image data source to a source driver providing the image data to a display panel, wherein the image data is stored in the image data sources in N frames, said N frames comprising a current frame and (N−1) previous frames, each of the N frame having a data size of n bit. The method comprises:

providing P memory chips for reading or writing the frame data in a line period;

separating each of the P memory chips into (N−1) parts so that each part is used to read a portion of frame data in a different one of the (N−1) previous frames and one part is used to write a portion of frame data in the current frame, wherein each of the P memory chips has a memory space of m bits, and wherein P is an integer greater than or equal to N multiplied by (n/m); and

transferring the frame data in N frames to the source driver.

When N=3 and the frame data in each frame is separable into an odd channel and an even channel, each channel having a plurality of row addresses, the row addresses comprising a first section and a second section, it is possible to have P=2 and the P memory chips comprise a first double data rate synchronous dynamic random access memory (DDR_SDRAM) chip and a second DDR_SDRAM chip, wherein

the first DDR_SDRAM chip is separated into a first part and a second part, the first part for reading or writing frame data in the first section of the row addresses in the odd channel and the second part for reading or writing frame data in the second section of the row addresses in the odd channel, and

the second DDR_SDRAM chip is separated into a first part and a second part, the first part for reading or writing frame data in the first section of the row addresses in the even channel and the second part for reading or writing frame data in the second section of the row addresses in the even channel.

According to one embodiment of the present invention, the current frame comprises frame data Gn, and the previous frames comprise frame data Gn-1 and frame data Gn-2, and wherein the line period is divided into a first sub-period, a second sub-period and a last sub-period, and the reading or writing of frame data is arranged such that

the frame data Gn-2 is read in the first sub-period;

the frame data Gn-1 is read in the second sub-period; and

the frame data Gn is written in the last sub-period.

The third aspect of the present invention is a timing control module for transferring image data to a display panel, wherein the image data is arranged for transferring in N frames. The time control module comprises:

P memory chips for reading or writing the frame data in a line period, wherein each of the P memory chips is separated into (N−1) parts so that each part is used to read a portion of frame data in a different one of the (N−1) previous frames and one part is used to write a portion of frame data in the current frame, and wherein each of N frames has a data size of n bits and each of the P memory chips has a memory space of m bits, and wherein P is an integer greater than or equal to N multiplied by (n/m).

According to one embodiment of the present invention, the line period is partitioned into N line period segments, so that the reading of the portion of the frame data in each different one of the (N−1) previous frames and writing of the portion of frame data in the current frame are carried out in different line period segments, and wherein the memory chips comprise double data rate synchronous dynamic random access memory chips.

According to the present invention, the timing control module further comprises:

a plurality of buffer memory chips for storing the frame data in a data transfer clock rate, and the double data rate synchronous dynamic random access memory chips are running at a clock rate substantially equal to 1.5 times the data transfer clock rate of the buffer memory chips.

According to the present invention, when N=3 and P=2, and the frame data comprises a front data part and a back data part. The timing control module further comprises:

a plurality of buffer memory chips, wherein

at least one of the buffer memory chips is arranged for transferring the front data part to one of the double data rate synchronous dynamic random access memory chips; and

at least another of the buffer memory chips is arranged for transferring the back data part to another of the double data rate synchronous dynamic random access memory chips.

According to the present invention, each of the front data part and the back data part comprises an odd data segment and an even data segment, wherein

said at least one of the buffer memory chips comprises one memory chip for transferring the even data segment in the front data part to said one of the double data rate synchronous dynamic random access memory chips, and another memory chip for transferring the odd data segment in the front data part to said one of the double data rate synchronous dynamic random access memory chips; and

said at least another of the buffer memory chips comprises one memory chip for transferring the even data segment in the back data part to said another of the double data rate synchronous dynamic random access memory chips, and another memory chip for transferring the odd data segment in the back data part to said another of the double data rate synchronous dynamic random access memory chips.

According to the present invention, the N frames include a current frame and two previous frames. The timing control module further comprises:

two different ones of the buffer memory chips for separately reading the front data part in the previous frames from said one of the double data rate synchronous dynamic random access memory chips;

another two different ones of the buffer memory chips for separately reading the back data part in the previous frames from said another of the double data rate synchronous dynamic random access memory chips; and

a further group of buffer memory chips for transferring the front and back data parts in the current frame, bypassing the double data rate synchronous dynamic random access memory chips.

The timing control module further comprises:

a comparator for receiving
the front data part in the previous frames from said two different ones of the buffer memory chips,
the back data part in the previous frames from said another two different ones of the buffer memory chips, and
the front and back data parts in the current frame from said further group of buffer memory chips for transferring the front and back data parts in the current frame.

The present invention will become apparent upon reading the description taken in conjunction with FIGS. 4 to 23.

### BRIEF DESCRIPTION OF THE DRAWINGS

FIG. 1 is a timing chart illustrating read/write timing of a frame memory in prior art.

FIG. 2 is a timing chart illustrating read/write timing of a buffer in prior art.

FIG. 3 is a timing chart regarding storing one frame data in one frame period using double clock rate in prior art.

FIG. 4 shows a typical timing control architecture for driving a display panel using image data from a VGA card.

FIG. 5 shows the relationship between the pixel period and the signals sent to the display panel.

FIG. 6 shows a timing control architecture including DDR_SDRAM for driving a display panel using image data from a VGA card.

FIG. 7 shows a direct approach in using two DDR_SDRAM chips to access three frame data during one line period.

FIG. 8 shows the relationship between the pixel period and the clock signal to the DDR_SDRAM.

FIG. 9 shows the partition of DDR_SDRAM and the allocation of row addresses in the partition.

FIG. 10 shows the organization of frame data in DDR_SDRAM in an odd-numbered frame.

FIG. 11 shows the organization of frame data in DDR_SDRAM in an even-numbered frame.

FIG. 12 shows the buffer memory in the timing control module, according to the present invention.

FIG. 13 shows the read/write operation regarding DDR_SDRAM in the first one-third of one line period.

FIG. 14 shows the data contents of the write operation regarding DDR_SDRAM in the first one-third of the line period.

FIG. 15 shows the read/write operation regarding DDR_SDRAM in the second one-third of the line period.

FIG. 16 shows the data contents of the write operation regarding DDR_SDRAM in the second one-third of the line period.

FIG. 17 shows the read/write operation regarding DDR_SDRAM in the last one-third of the line period.

FIG. 18 shows the data contents of the read operation regarding DDR_SDRAM in the last one-third of the line period.

FIG. 19A shows the read/write operation regarding SRAM buffer memory in the timing control module during the first half of the line period.

FIG. 19B shows the read/write operation regarding the SRAM buffer memory during the second half of the line period.

FIG. 20A shows the data contents of the write operation regarding the SRAM buffer memory in one line period.

FIG. 20B shows the data contents of the read operation regarding the SRAM buffer memory in one line period.

FIG. 21 shows the partition of DDR_SDRAM and the allocation of row addresses in the partition when three DDR_SRAM chips are used for frame data transfer.

FIG. 22 shows the organization of frame data in DDR_SDRAM in F4, F7, F10 . . . when three DDR_SRAM chips are used for frame data transfer.

FIG. 23 shows the organization of frame data in DDR_SDRAM in F5, F8, F11 . . . when three DDR_SRAM chips are used for frame data transfer.

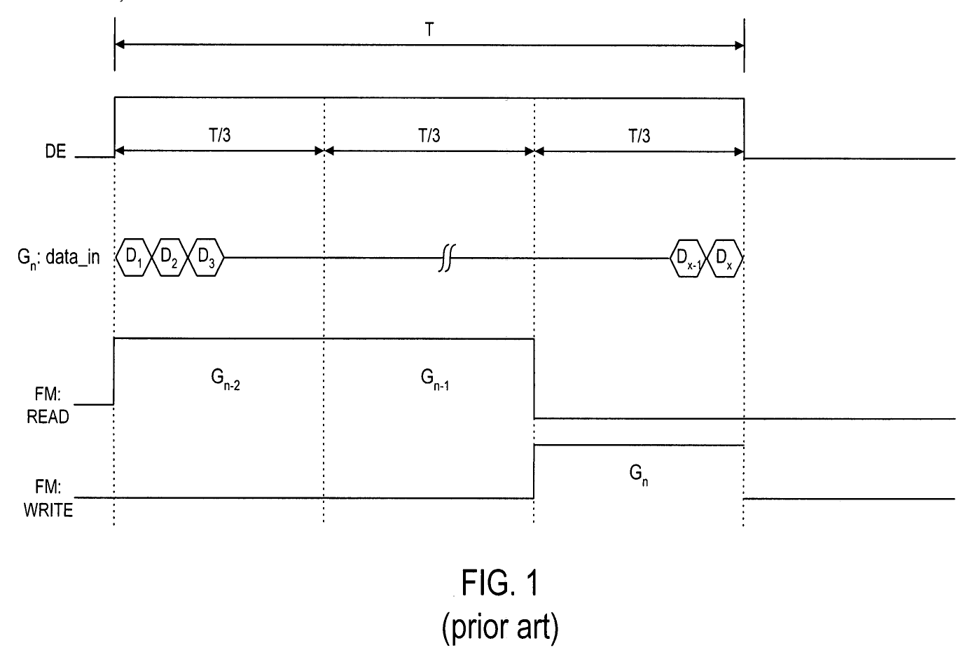

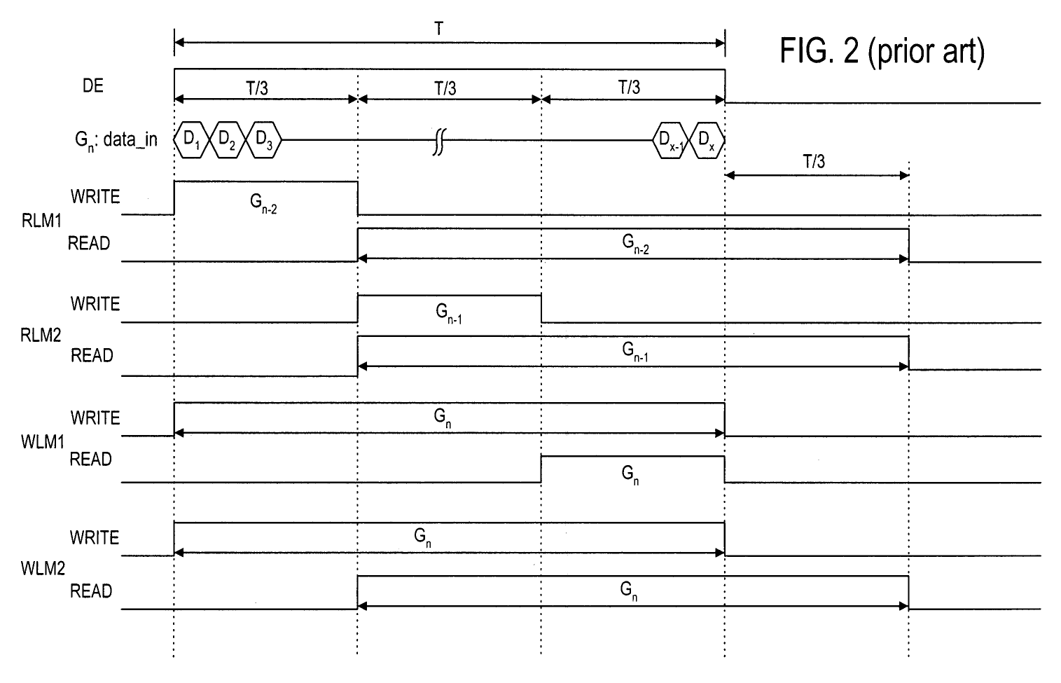

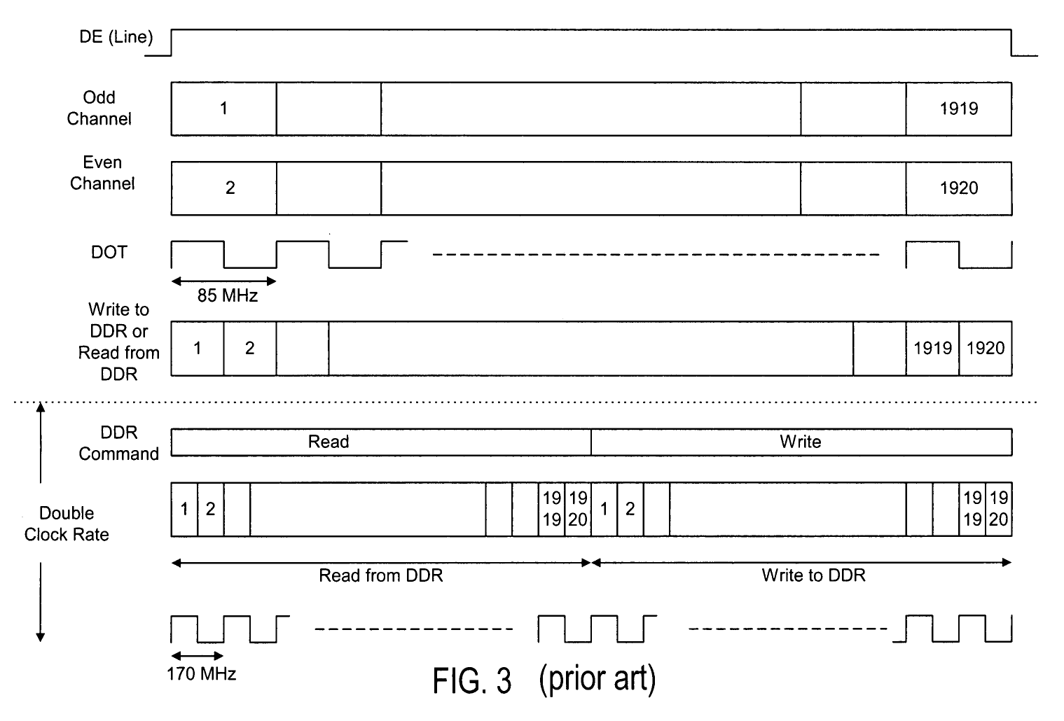

### DETAILED DESCRIPTION OF THE INVENTION

The present invention uses P DDR_SDRAM chips to store frame data in N frames using a different clock rate. Take N=3 as an example. The present invention uses 2 DDR_SDRAM chips for storing the frame data in a different rate in order to minimize the number of chips. As such, a line period is partitioned into 3 segments so that the current frame data Gn can be written while the previous frame data Gn-1 and Gn-2 are read at different line segments. Furthermore, each chip is separated into 2 parts so that only one part is used to read or write the frame data at a line segment. More specifically, when N=3, a line period is partitioned into three segments so that the reading of frame data in frame F1 and frame data in frame F2 and the writing of frame data F3 can be carried out sequentially within one line period. To meet the storage requirement, two 4 M×32 bit DDR_SDRAM devices are used for storing three frame data of 66 Mbit each. Instead of running at double clock rate capability of DDR_SDRAM, the present invention uses 1.5 clock rate. As such, the present invention is capable of supporting the 0.25 μm fabrication process associated with SSTL_{—}2 specification. Also, the system can be more stable when using the lower 1.5 clock rate rather than the higher 2.0 clock rate.

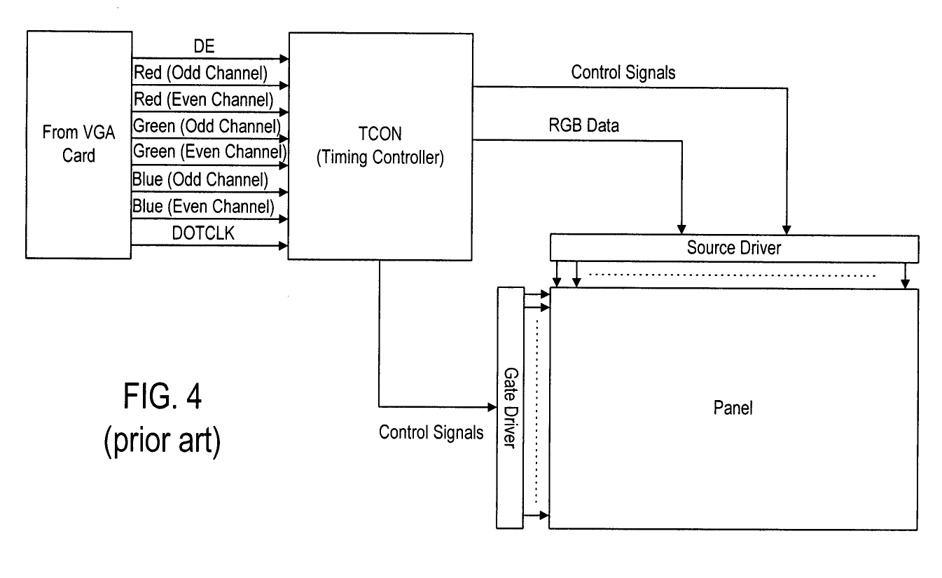

When a VGA card is used to provide image data to a display panel, a timing control module is used as an interface between the VGA card and the display panel. As shown in FIG. 4, the timing control module (TCON) receives the data enable signal (DE), the image data in R, G, B and a clock signal DOTCLK from the VGA card. Here a DOTCLK cycle is a time period of one pixel. The timing control module is used to convey pixel data from the VGA card to the source driver. It may carry out some image processing tasks such as overdrive. The timing control module also sends a control signal (line DE) to the gate driver.

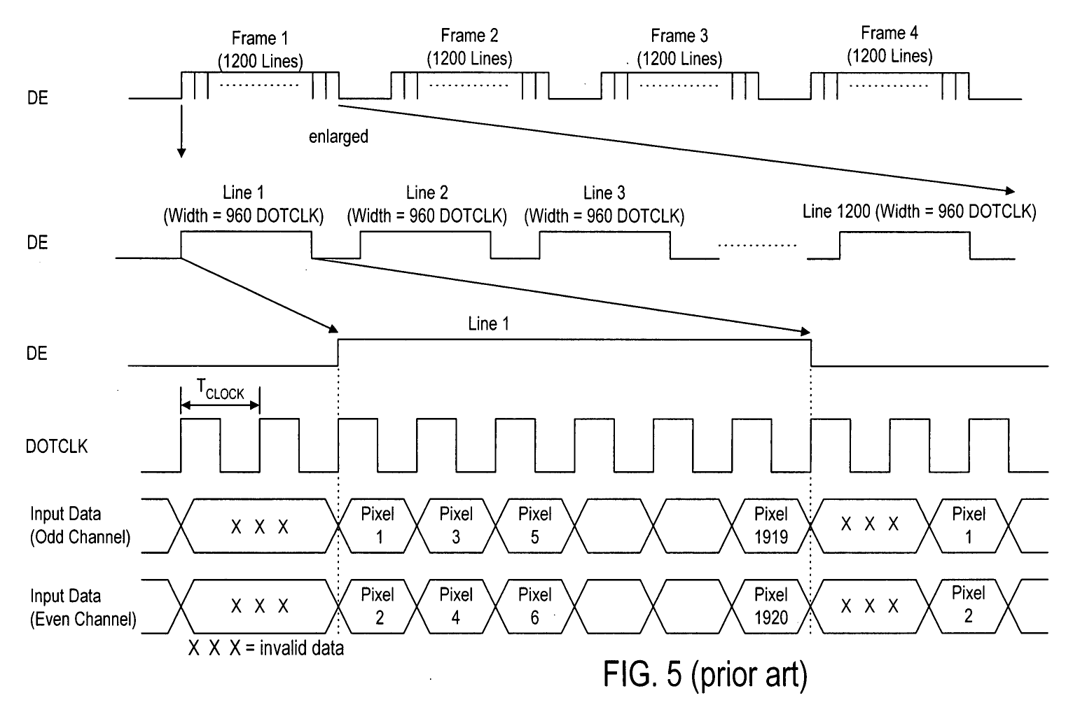

In a display with a 1920×1200 resolution, there are 1200 lines on the display in a time period of one frame, and each of the lines has 1920 pixels. Because of the frequency restriction of the interface between the timing control module and the source driver, and between the timing control module and the VGA card, it is necessary to separate the 1920 pixels into two channels, each of which has 960 pixels. With a DOTCLK cycle or period being a time period of one pixel, the width of the DE signal for one line is 1920/2 (=960) DOTCLK periods. The relationship between the frame DE, line DE, DOTCLK and image data is shown in FIG. 5. It should be noted that the total number of data (pixels) during one frame time is 1920 (pixels)×1200 (lines)×3(RGB)×10 (bits)=66 Mbit.

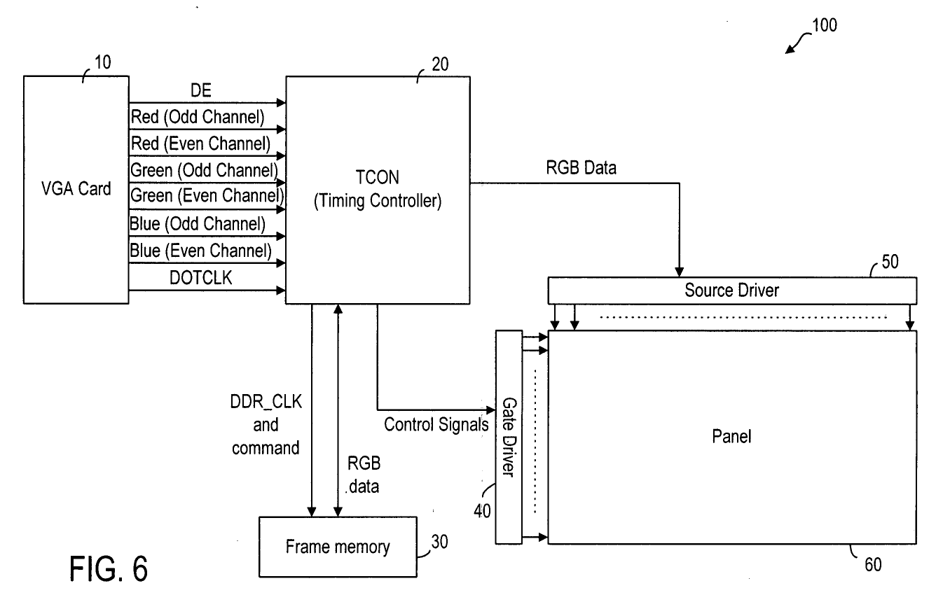

To illustrate how DDR_SDRAM is efficiently used for data transfer between a VGA card and a display panel, another timing control architecture is shown in FIG. 6. As shown, the timing control architecture 100 comprises a timing control module 20 for use an interface between a VGA card 10 and a display panel 60. The timing control module 20 is adapted to send control signals and image data to the display panel 60 through the gate driver 40 and the source driver 50. Here a frame memory module 30 including DDR_SDRAM is used to provide frame storage or buffer.

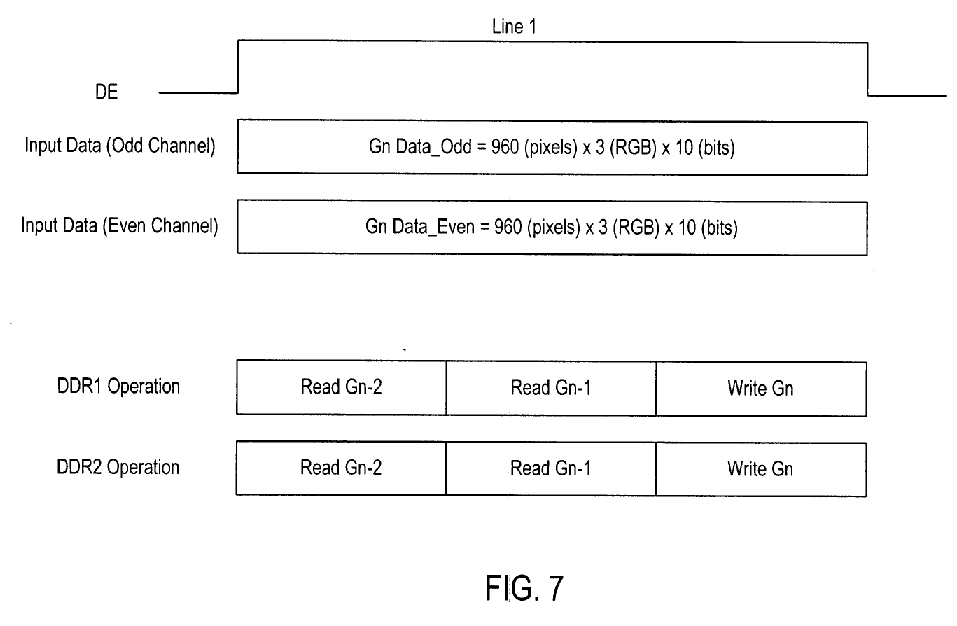

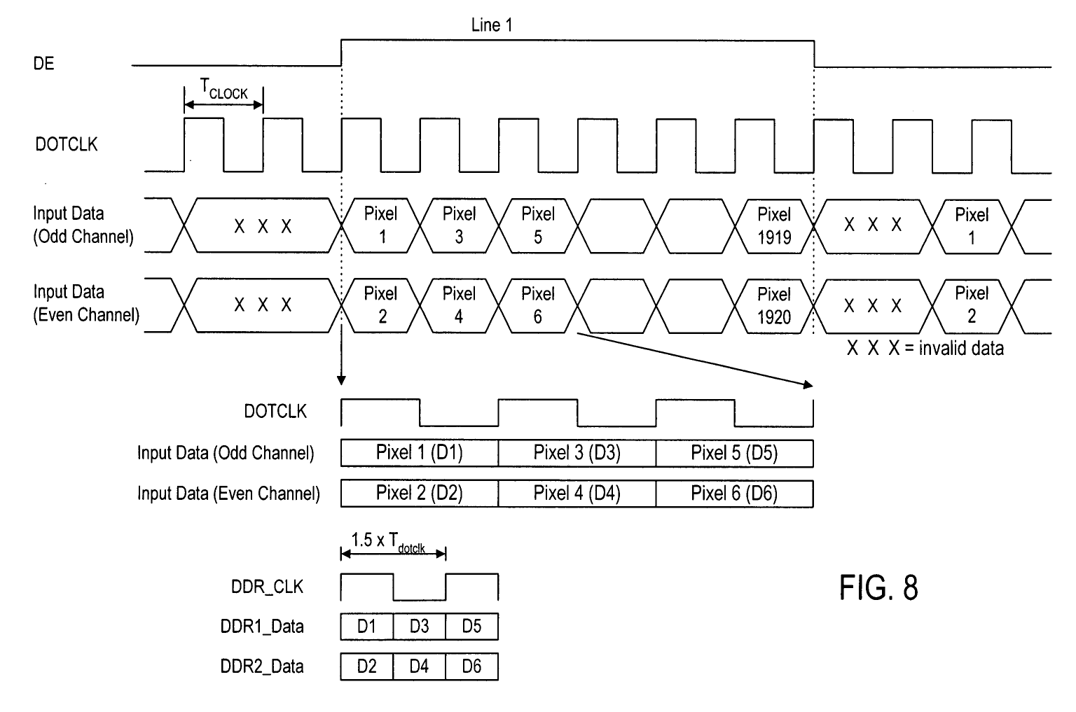

To control the read/write operations in the DDR_SDRAM chips, the timing control module 20 provides a DDR_CLK clock signal to the frame memory module 30. To access the frame data in three frames during one line period, it is possible to read the frame data of the previous two frames in the first two-third of the line period, and to store the frame data of the current frame in the last one-third of the line period, as shown in FIG. 7. In FIG. 7, Gn denotes the current frame data, Gn-1 and Gn-2 denote the previous two frame data. Also, input data is separated into an odd channel and an even channel. One DDR_SDRAM chip is used to read or write the odd channel data while the another DDR_SDRAM chip is used to read or write the even channel data. Because DDR_SDRAM can access data at both the rising and falling edges of DDR_CLK, it is possible to store one frame data (Gn) and read two previous frame data (Gn-1, Gn-2) during one line period by using the DDR_CLK that is equal to 1.5 times DOTCLK. The relationship between DOTCLK and DDR_CLK is shown in FIG. 8. By using DDR_SDRAM according to the method as shown in FIGS. 7 and 8, we need four 4 M×32 bit DDR_SDRAM chips or units. This implementation wastes a lot of memory and I/O pins.

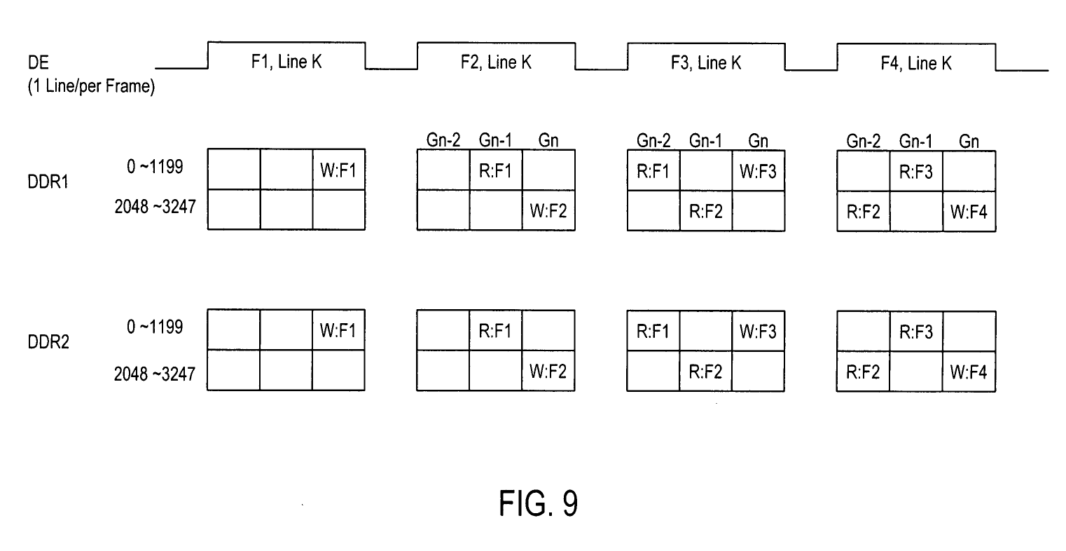

The present invention uses a different approach. The present invention starts out by separating DDR_SDRAM into two parts. One part (a) is used to read or write image data with row addresses from 0 to 2047, and the other part (b) is used to read or write image data with row addresses from 2048 to 4095 when the total number of row addresses is 4096. Here the assigned row addresses in each part is equal to one half of 4096. FIG. 9 shows the read/write sequence and the timing for reading one line of data (Line K). As shown in FIG. 9, the frame data of frame F 1 is written into row addresses 0 to 1199 of part (a) of one DDR_SDRAM (DDR1) in the last ⅓ line period of frame F1. Subsequently, frame data of F1 in row addresses 0 to 1199 of part (a) is read during the second ⅓ line period of next frame F2, and frame data of F2 in row addresses 2048 to 3247 of part (b) is written during the last ⅓ line period of frame F2.

In the line period of the following frame F3, frame data of F1 in row addresses 0 to 1199 of part (a) is read during the first ⅓ line period; frame data of frame F2 in row addresses 2048 to 3247 of part (b) is read during the second ⅓ line period; and frame data of frame F3 is written into row addresses 0 to 1199 of part (a) during the last ⅓ line period.

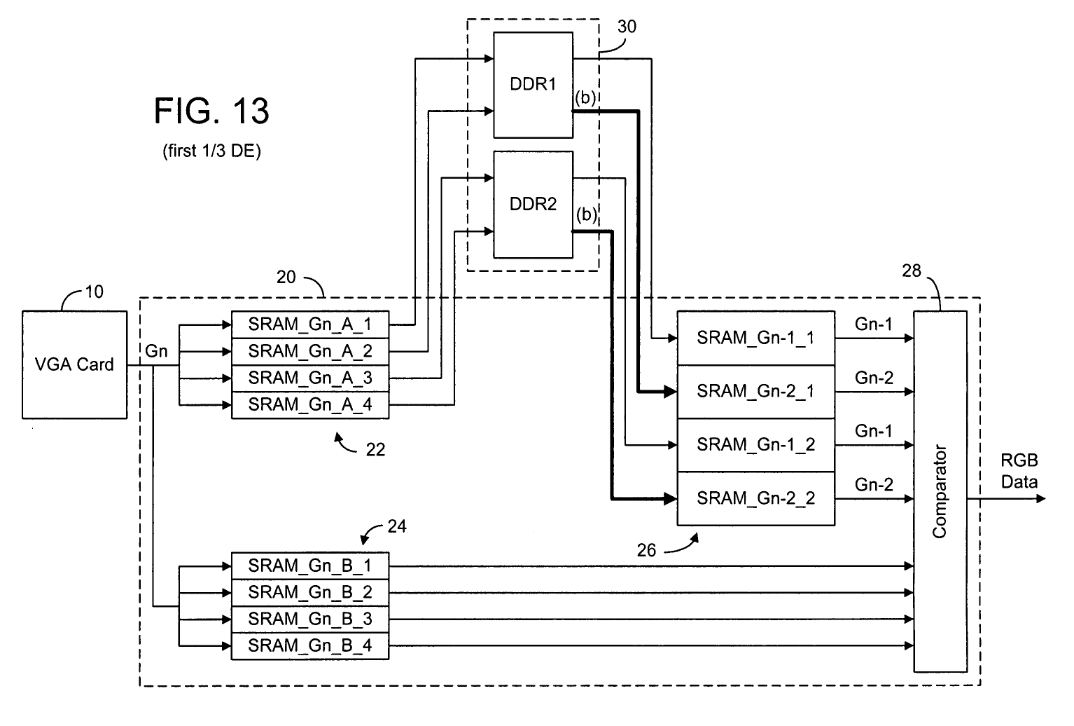

In order to share I/O pins when using two DDR_SDRAM chips, the read/write sequence for the second DDR_SDRAM (DDR2) follows the same command and address. Again, DDR2 is separated into part (a) and part (b). The data read/write operation in part (a) and part (b) of DDR2 is identical to corresponding parts of DDR1. DDR1 and DDR2 are shown in FIG. 12.

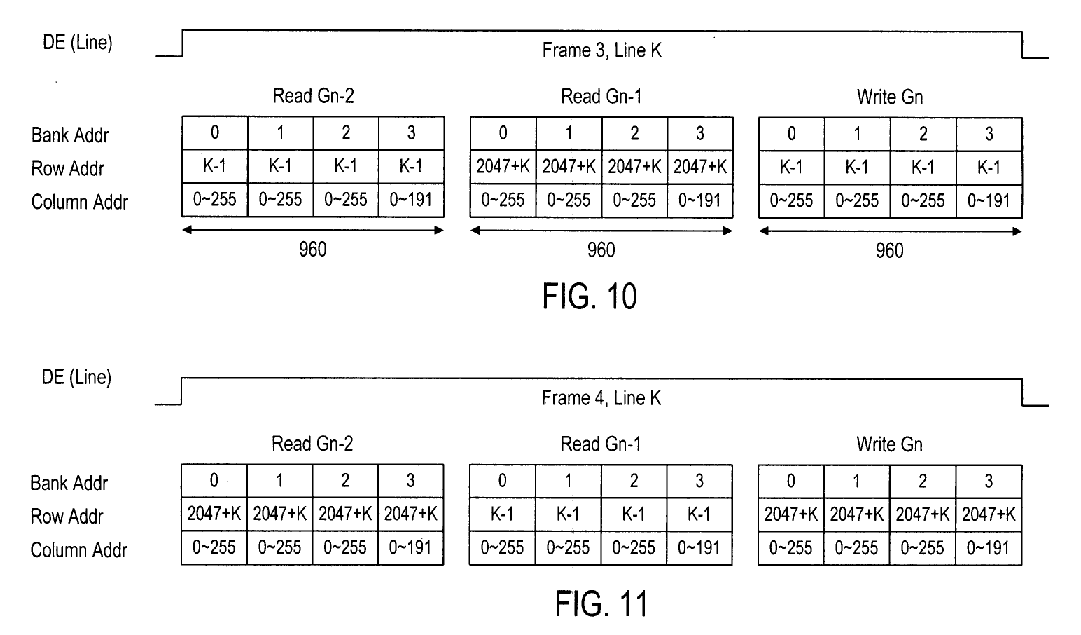

Because the total bits for one frame data having 1920×1200 resolution are 66 Mbit, it is required to have a memory space of 132 Mbit to store two frame data. However, one 4 M×32 DDR_SDRAM chip has only 128 Mbit memory space. We need two such DDR_SDRAM chips. With two DDR_SDRAM chips of a 128 Mbit memory space each or a total memory space of 256 Mbits, it is possible to store three frame data of a total 198 Mbits. As shown in FIG. 9, when the DE timing reaches frame F3, both DDR1 and DDR2 contain three frame data. The detail of the driving of DDR_SDRAM in F3 is shown in FIG. 10. The bank addresses 0, 1, 2 and 3 indicate the data banks in the synchronous random access memory (SRAM) buffer in the VGA card. The read/write sequence of Gn-2, Gn-1, Gn data in F3 will be repeated in F5, F7, . . .

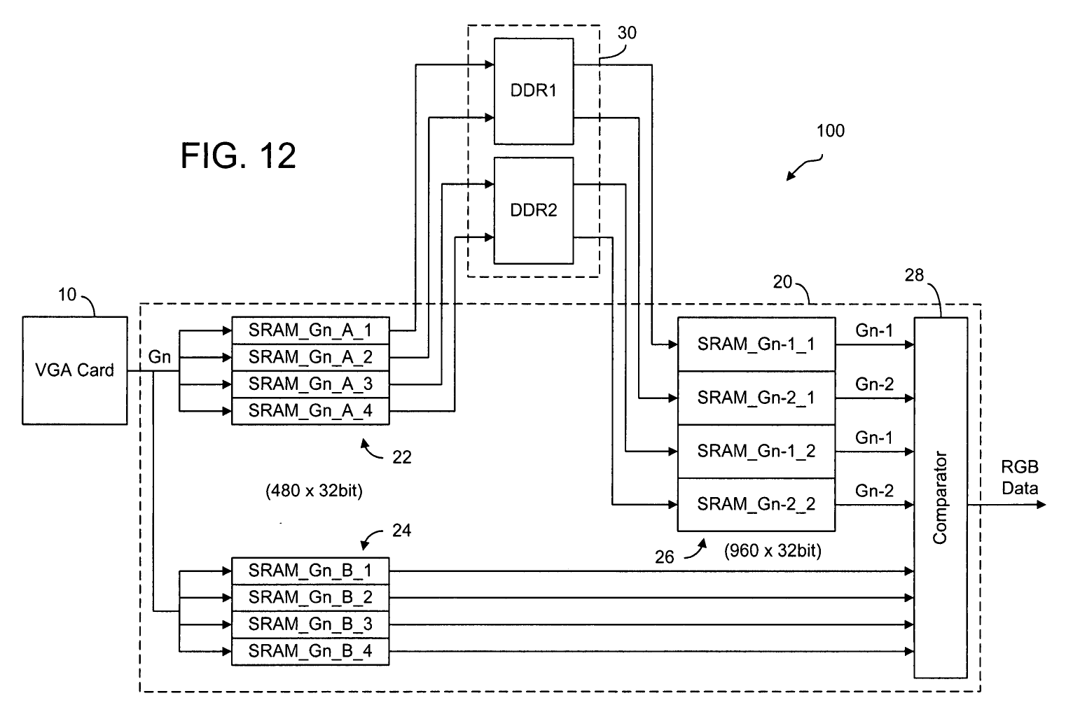

The read/write sequence of Gn-2, Gn-1, Gn data in F4, F6, F8, . . . is the same as that in F3, F5, . . . . However, the row addresses are different. The detail of the driving of DDR_SDRAM in F4 is shown in FIG. 11.

The pattern of the read/write sequence regarding row addresses 0 to 1199 of part (a), and the timing in one line period of any frame Fn can be summarized as follow:

Let Gn be the frame data of frame Fn, Gn-1 be the frame data of frame Fn-1 and Gn-2 be the frame data of frame Fn-2, then

in the first ⅓ line period of frame Fn, read frame data Gn-2, if n is odd and n>2;

in the second ⅓ line period of frame Fn, read frame data Gn-1, if n is even and n>1; and

in the last ⅓ line period of frame Fn, write frame data Gn, if n is odd.

Likewise, the pattern of the read/write sequence reading row addresses 2048 to 3247 of part (b) and the timing in one line period of frame Fn can be summarized as follows:

In the first ⅓ line period of frame Fn, read frame data Gn-2, if n is even and n>3;

in the second ⅓ line period of frame Fn, read frame data Gn-1, if n is odd and n>2; and

in the last ⅓ line period of frame Fn, write frame data Gn, if n is even and n>1.

### To state it differently, in one line period of a frame Fn:

### If n is odd and n>2:

in the first ⅓ line period, read frame data Gn-2 in part (a);

in the second ⅓ line period, read frame data Gn-1 in part (b); and

in the third ⅓ line period, write frame data Gn into part (a).

### If n is even and n>3,

in the first ⅓ line period, read frame data Gn-2 in part (b);

in the second ⅓ line period, read frame data Gn-1 in part (a); and

in the third ⅓ line period, write frame data Gn into part (b).

According to the present invention, the timing control module 20 comprises three groups of SRAM memory chips, as shown in FIG. 12. As shown, four SRAM memory chips 22 are used for transferring the Gn frame data from the VGA card 10 to the DDR_SDRAM chips in the frame memory module 30. Each SRAM chip has a storage capacity of 480×32 bits. Among the SRAM chips 22, SRAM_Gn_A_1 is used as a buffer for Front Even frame data; SRAM_Gn_A_2 is used as a buffer for Front Odd frame data; SRAM_Gn_A_3 is used as a buffer for Back Even frame data; and SRAM_Gn_A_4 is used as a buffer for Back Odd frame data.

In addition, four SRAM memory chips 24 are used to transfer Gn frame data directly to a comparator device 28. Among the SRAM chips 24, SRAM_Gn_B_1 is used as a buffer for Front Even frame data; SRAM_Gn_B_2 is used as a buffer for Front Odd frame data; SRAM_Gn_B_3 is used as a buffer for Back Even frame data; and SRAM_Gn_B_4 is used as a buffer for Back Odd frame data.

Four larger SRAM chips (960×32 bit) 26 are used as buffer between the DDR_SDRAM chips in the memory module 30 and the comparator 28. More specifically, the SRAM chips 26 are used for transferring Gn-1 and Gn-2 frame data from the frame memory module 30 to the comparator 28. Among the SRAM chips 26, SRAM_Gn-1_1 is used as a buffer for Front Even and Odd frame data in Gn-1; SRAM_Gn-1_2 is used as a buffer for Back Even and Odd frame data in Gn-1; SRAM_Gn-2_1 is used as a buffer for Front Even and Odd frame data in Gn-2 and SRAM_Gn-2_2 is used as a buffer for Back Even and Odd frame data in Gn-2.

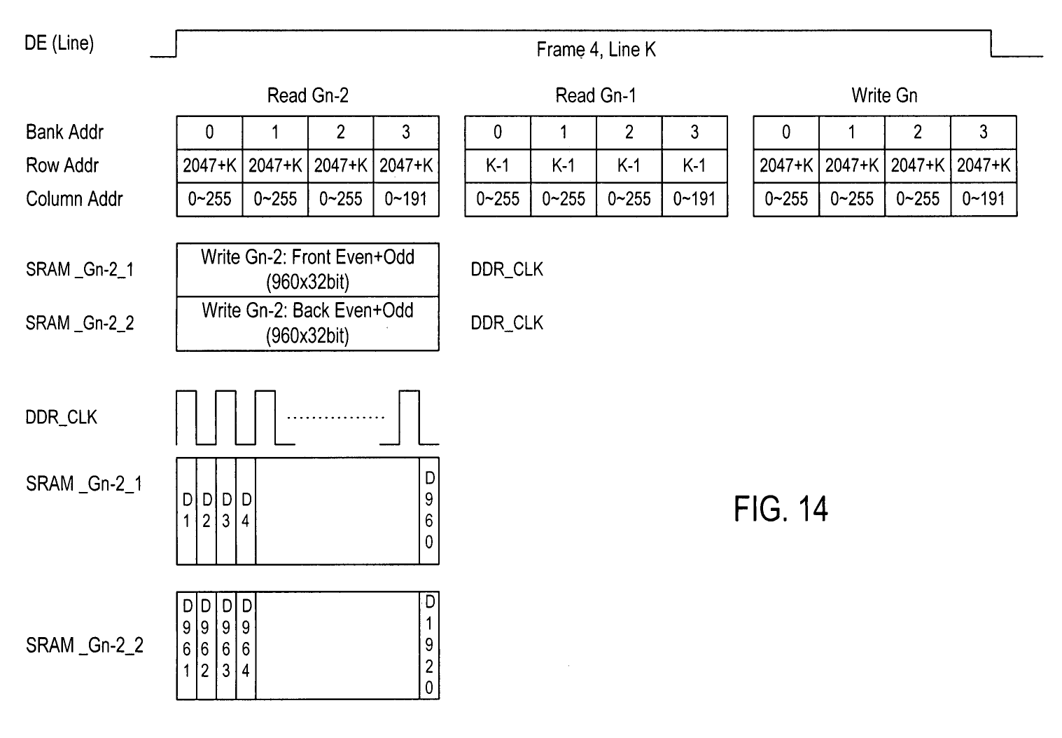

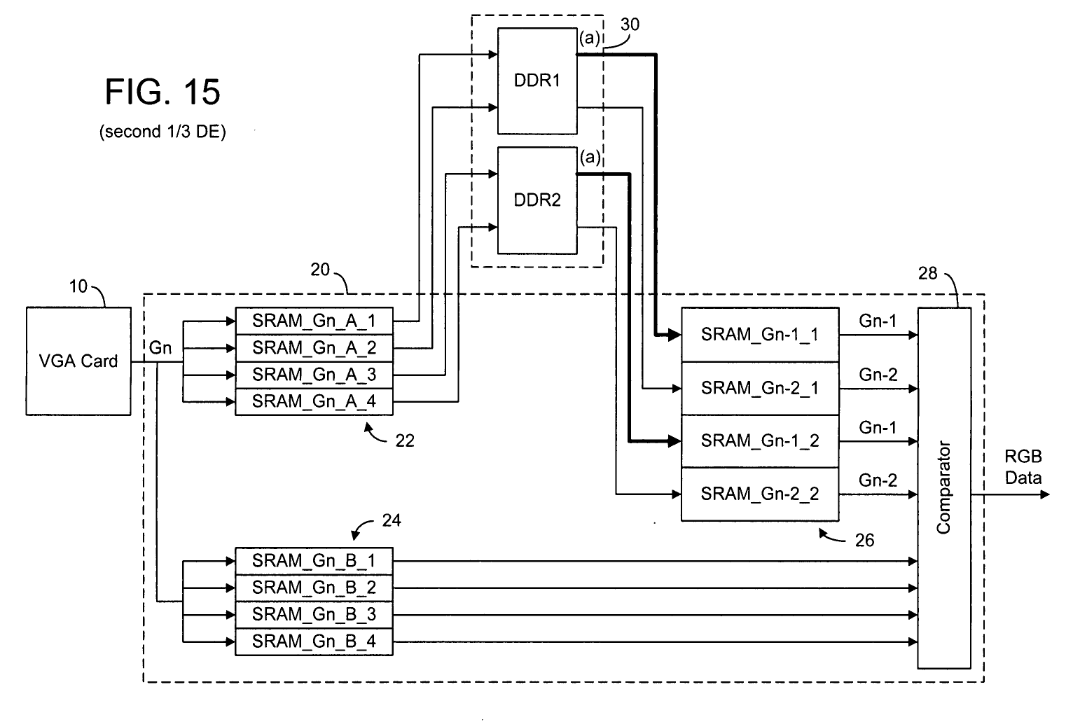

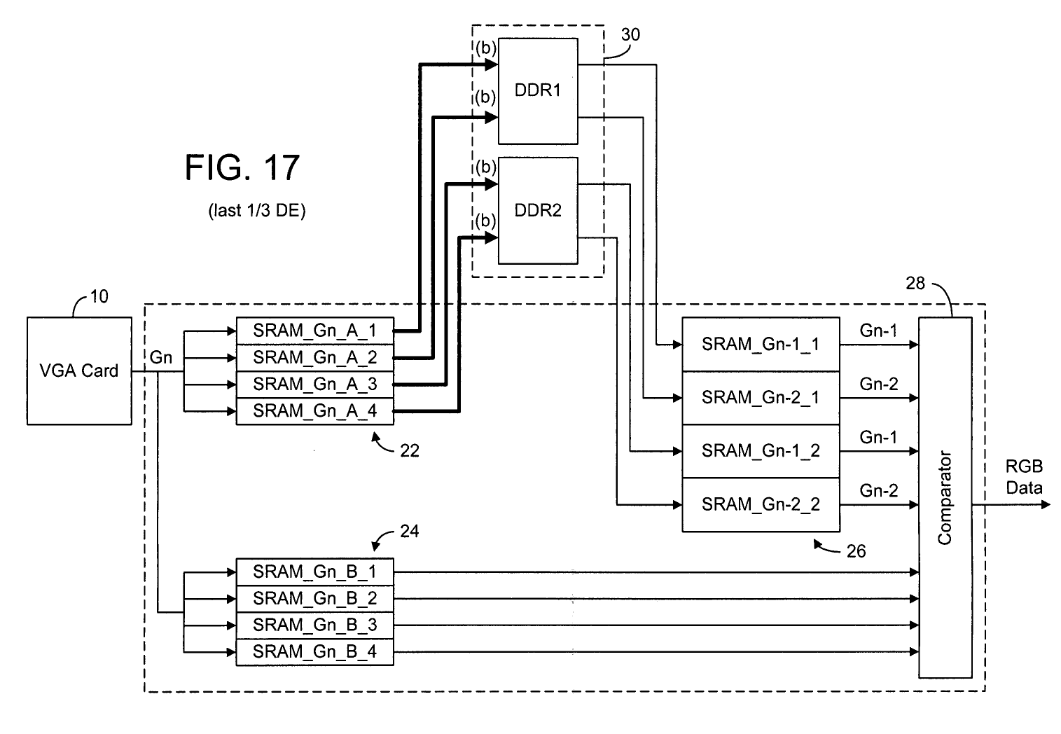

To illustrate the read/write operation of the DDR_SDRAM regarding a line period of Fn (n being even, greater than 3), the timing control architecture in the timing control module 20 along with the VGA card 10 and the frame memory module 30 is used to show the data transfer in different ⅓ line periods in FIGS. 13-18.

Referring now to FIGS. 13, 14 and 19B, Gn-2 frame data is read from part (b) of both DDR1 and DDR2 and written into SRAM_Gn-2_1 and SRAM_Gn-2_2 during the first ⅓ line period of frame Fn. The same frame data will be read out from SRAM_Gn-2_1 and SRAM_Gn-2_2 and conveyed to the comparator 28 during the second half of the line period. SRAM_Gn-2_1 contains the Front Even and Odd Gn-2 frame data, and SRAM_Gn-2_2 contains the Back Even and Odd Gn-2 frame data. The write operation is effected by DDR_CLK signals.

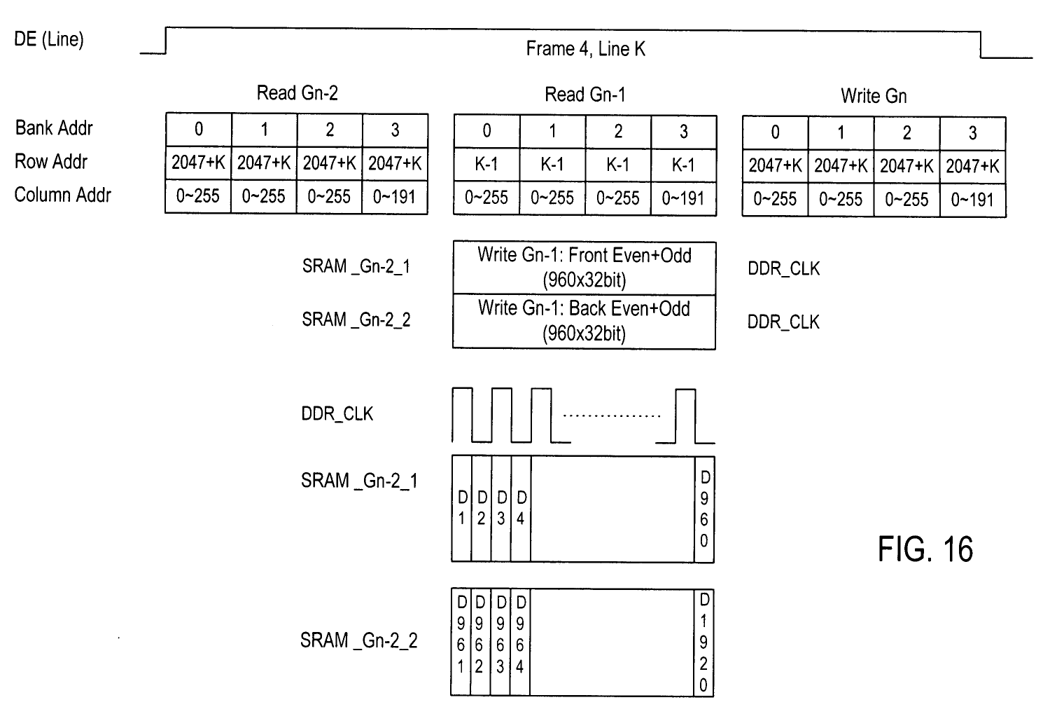

Referring now to FIGS. 15, 16 and 19B, Gn-1 frame data is read from part (a) of both DDR1 and DDR2 and written into SRAM_Gn-1_1 and SRAM_Gn-1_2 during the second ⅓ line period of frame Fn. The same frame data will be read out from SRAM_Gn-1_1 and SRAM_Gn-1_2 and conveyed to the comparator 28 during the second half of the line period. SRAM_Gn-1_1 contains the Front Even and Odd Gn-1 frame data, and SRAM_Gn-1_2 contains the Back Even and Odd Gn-1 frame data. The write operation is effected by DDR_CLK signals.

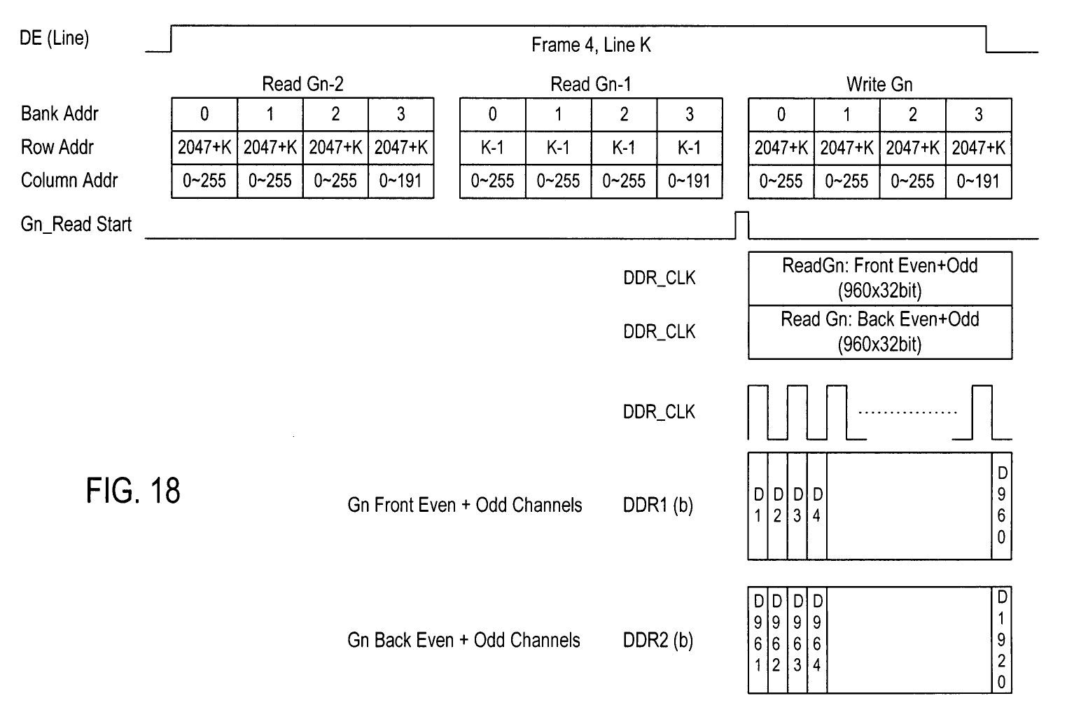

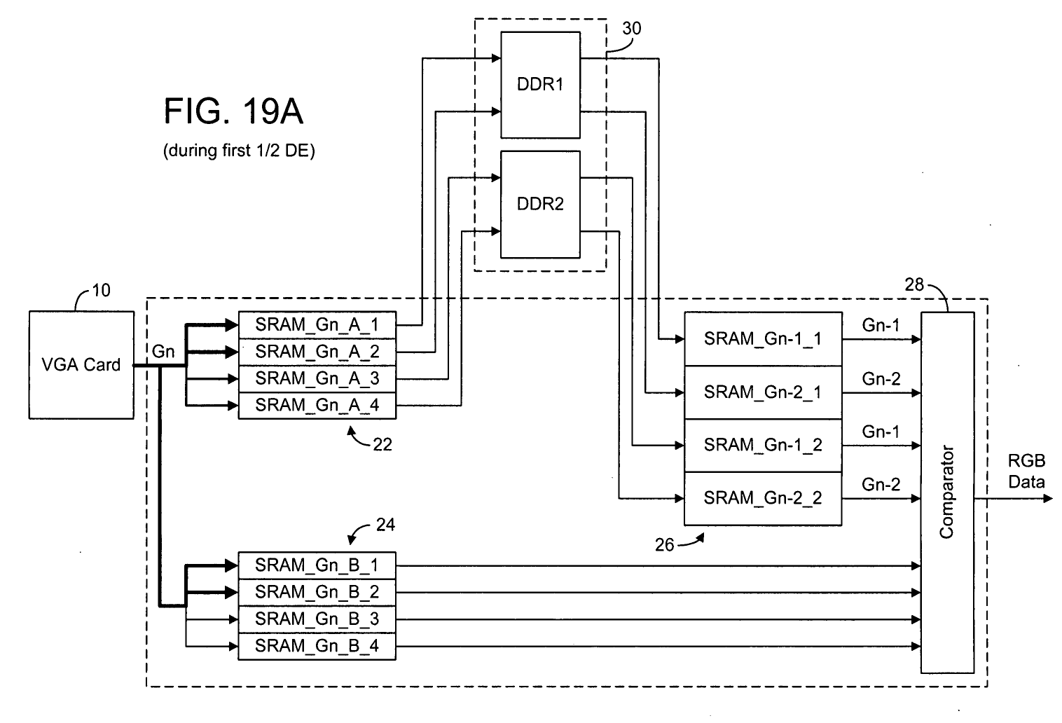

Referring now to FIG. 17, Gn frame data is read from SRAM_Gn_A_1, SRAM_Gn_A_2, SRAM_Gn_A_3, and SRAM_Gn_A_4 and written into part (b) of both DDR1 and DDR2 during the last ⅓ line period of frame Fn. As mentioned earlier, SRAM_Gn_A_1 contains Front Even Gn frame data; SRAM_Gn_A_2 contains Front Odd Gn frame data; SRAM_Gn_A_3 contains Back Even Gn frame data; and SRAM_Gn_A_4 contains Back Odd Gn frame data. The contents of the Gn frame data is shown in FIG. 18, which shows the Front Even and Odd Gn frame data is written into part (b) of DDR1 while the Back Even and Odd Gn frame data is written into part (b) of DDR2. The write operation is effected by DDR_CLK signals.

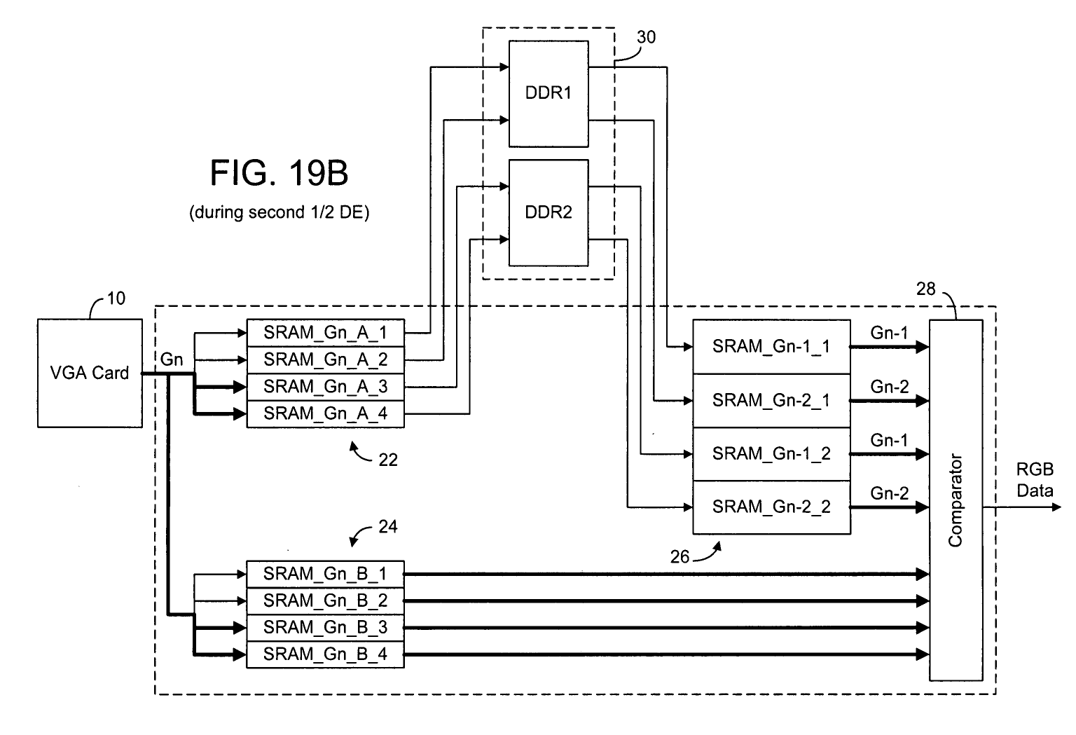

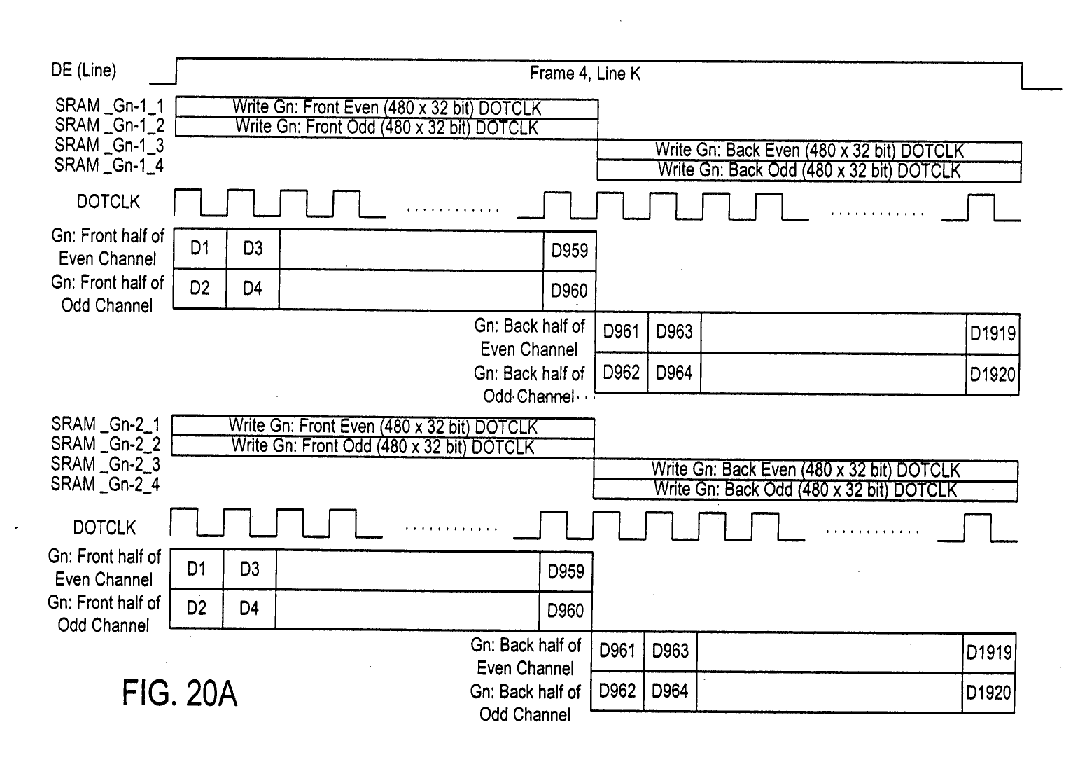

As shown in FIGS. 19A and 19B, during the first half of the line period, the Front Even Gn frame data is written into both SRAM_Gn_A_1 and SRAM_Gn_B_1, and Front Odd Gn frame data is written into both SRAM_Gn_A_2 and SRAM_Gn_B_2. During the second half of the line period, Back Even Gn frame data is written into both SRAM_Gn_A_3 and SRAM_Gn_B_3, and Back Odd Gn frame data is written into both SRAM_Gn_A_4 and SRAM_Gn_B_4. The contents of the write operation during the first and second halves of the line period are shown in FIG. 20A. The contents of the read operation during the second halves of the line period are shown in FIG. 20B.

During the second half of the line period, data in the SRAM memory 26 and the data in the SRAM memory 24 are read and conveyed to the comparator 28.

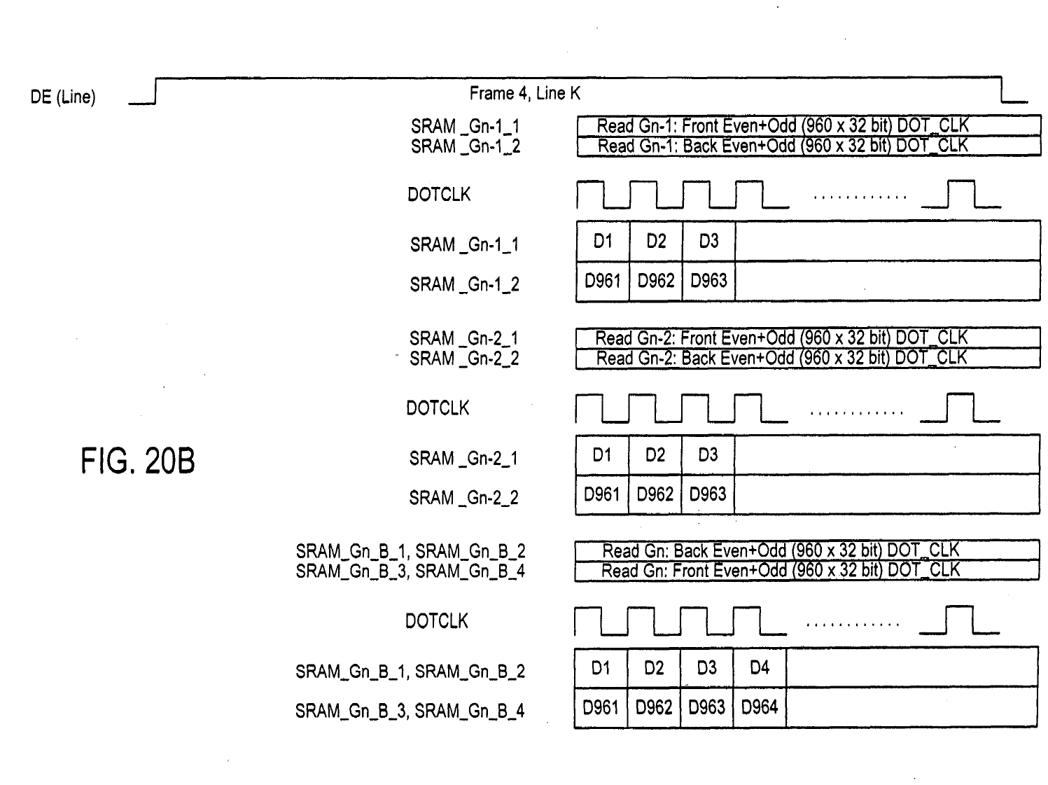

It should be noted that the minimum number of DDR_SDRAM chips would be greater when the more frame data is transferred. FIGS. 21-23 show the read and write operation in the transfer of frame data in 4 frames. In this case, a line period is partitioned into four segments so that the reading of frame data in frame F1, F2 and F3 and the writing of frame data F4 can be carried out sequentially within one line period. To meet the storage requirement, three 4 M×32 bit DDR_SDRAM devices are used for storing four frame data of 66 Mbit each. Instead of running at double clock rate capability of DDR_SDRAM, the present invention uses 1.5 clock rate. The present invention starts out by separating DDR_SDRAM into three parts. Part (I) is used to read or write image data with row addresses from 0 to 1364; part (II) is used to read or write image data with row addresses from 1365 to 2729 and part (III) is used to read or write data with the remaining row addresses when the total number of row addresses is 4096. Here the partition is made so that the assigned addresses in each part is approximately equal to one third of 4096.

FIG. 21 shows the read/write sequence and the timing for reading one line of data (Line K) in a frame having 1920×1200 resolution, for example. As shown in FIG. 21, the frame data of frame F1 is written into row addresses 0 to 1199 of part (I) of one DDR_SDRAM (DDR1) during the last ¼ line period of frame F1. Next, the frame data of F1 in row addresses 0 to 1199 of part (I) is read during the third ¼ line period of frame F2, and the frame data of F2 is written into row addresses 1365 to 2564 of part (II) during the last ¼ line period of frame F2. Subsequently, the frame data of F1 in row addresses 0 to 1199 of part (I) is read during the second ¼ line period of frame F3; the frame data of F2 in row addresses of part (II) is read during the third ¼ line period of frame F3, and the frame data of F3 is written into row addresses 2730-3929 of part (III) during the last period of F3.

In the line period of the following frame F4, frame data of F1 in row addresses 0 to 1199 of part (I) is read during the first ¼ line period; frame data of frame F2 in row addresses 1365 to 2564 of part (II) is read during the second ¼ line period; frame data of F3 in row addresses 2710-3929 of part (III) is read during the third ¼ line period; and frame data of frame F4 is written into row addresses 0 to 1199 of part (I) during the last ¼ line period.

In order to share I/O pins when using three DDR_SDRAM chips, the read/write sequence for the second DDR_SDRAM (DDR2) and the third DDR_SDRAM (DDR3) follows the same command and address. Again, DDR2 and DDR3 are each separated into part (I), part (II) and part (III). The data read/write operation in part (I), part (II) and part (III) of DDR2 and DDR3 is identical to corresponding parts of DDR1.

Because the total bits for one frame data having 1920×1200 resolution are 66 Mbit, it is required to have a memory space of 264 Mbit to store four frame data. However, one 4 M×32 DDR_SDRAM chip has only 128 Mbit memory space. We need three such DDR_SDRAM chips. With three DDR_SDRAM chips of a 128 Mbit memory space each or a total memory space of 384 Mbits, it is possible to store four frame data of a total 264 Mbits or five frame data of a total 330 Mbits.

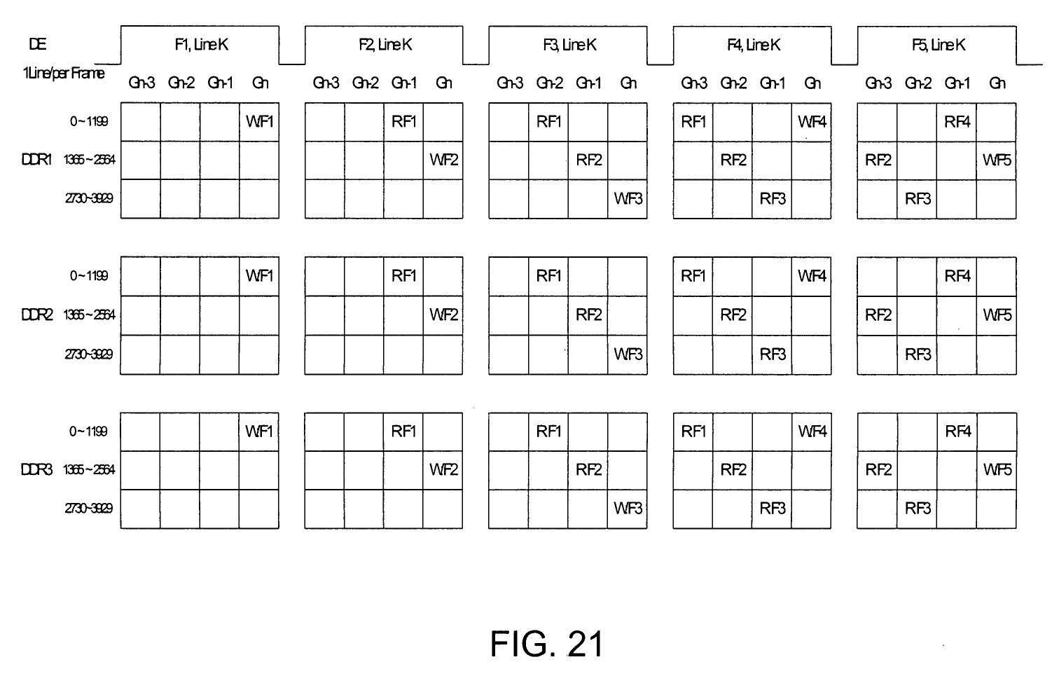

As shown in FIG. 21, when the DE timing reaches frame F4, all DDR1, DDR2 and DDR3 contain four frame data. The detail of the driving of DDR_SDRAM chips in F4 is shown in FIG. 22. The bank addresses 0, 1, 2 and 3 indicate the data banks in SRAM data in the VGA card. The read/write sequence of Gn-3, Gn-2, Gn-1, Gn data in F4 will be repeated in F7, F10,

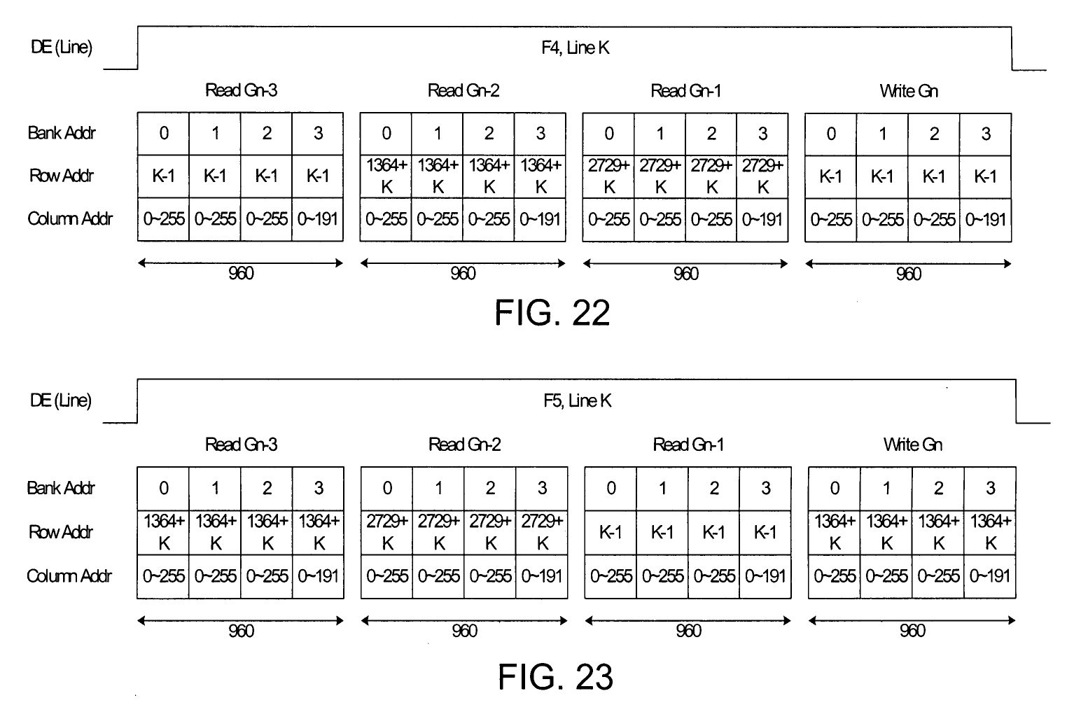

The read/write sequence of Gn-3, Gn-2, Gn-1, Gn data in F5, F8, F11, . . . is the same as that in F4, F7, . . . . However, the row addresses are different. The detail of the driving of DDR_SDRAM in F5 is shown in FIG. 23.

In sum, the present invention uses P DDR_SDRAM chips to store frame data in N frames using a different clock rate. If the frame date in each of the N frames is n bits and the memory space in the DDR_SDRAM chip is m, then P is an integer which is not smaller than the smallest integer equal to or greater than N multiplied by (n/m). For example, if n is 66 Mbits and m is 128 Mbits, then the smallest P is 2 when N=3. When N=4 or 5, the smallest P is 3. When P DDR_SDRAM chips are used to store frame data, a line period is partitioned into N segments and each DDR-SDRAM chip is separated into (N−1) parts such that the parts are used to read different data in the different frames. The (N−1) parts are arranged to write and read the previous frame data in (N−1) frames in a cyclic manner such that the read and write sequence in frame F(Q) is the same as that in frame F(Q+N−1), where Q is greater than or equal to N. The above-illustrated examples are based on the frame data for 1920×1200 resolution with 3 colors of 10 bits deep and the memory space for the 4 M×32 bit DDR_SDRAM chips running at 1.5 clock rate. The minimum number, P, varies with the resolution and the memory space of the DDR_SDRAM chips.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A method for transferring frame data in N frames, said N frames comprising a current frame and (N−1) previous frame, comprising:
providing P memory chips for reading or writing the frame data in a line period; and
separating each of the P memory chips into (N−1) parts so that each part is used to read a portion of frame data in a different one of the (N−1) previous frames and one part is used to write a portion of frame data in the current frame.

2. The method of claim 1, wherein each of N frames has a data size of n bits and each of the P memory chips has a memory space of m bits, and wherein P is an integer greater than or equal to N multiplied by (n/m).

3. The method of claim 1, further comprising:
partitioning a line period in a frame of said N frames into N line period segments, so that reading of the portion of the frame data in each different one of the (N−1) previous frames and writing of the portion of frame data in the current frame are carried out in different line period segments.

4. The method of claim 3, wherein the N line period segments include a last segment preceded by (N−1) segments, and wherein the reading is carried out in said (N−1) preceding segments and the writing is carried out in the last segment.

5. The method of claim 4, wherein the (N−1) preceding segments include a first segment and wherein the reading in the first segment and the writing in the last segment are carried out in a same part of the P memory chips.

6. The method of claim 1, wherein the memory chips comprise double data rate synchronous dynamic random access memory chips.

7. The method of claim 6, wherein the frame data are stored in a plurality of buffer memory chips before transferring and the buffer memory chips have a data transfer clock rate, said method further comprising:
running the double data rate synchronous dynamic random access memory chips at a clock rate substantially equal to 1.5 times the data transfer clock rate of the buffer memory chips.

8. The method of claim 7, wherein the frame data comprises a front data part and a back data part, said method further comprising:
arranging at least one of the buffer memory chips for transferring the front data part to one of the double data rate synchronous dynamic random access memory chips; and
arranging at least another of the buffer memory chips for transferring the back data part to another of the double data rate synchronous dynamic random access memory chips.

9. The method of claim 8, wherein each of the front data part and the back data part comprises an odd data segment and an even data segment, said method further comprising:
arranging one of said at least one of the buffer memory chips for transferring the even data segment in the front data part to said one of the double data rate synchronous dynamic random access memory chips;
arranging another of said at least one of the buffer memory chips for transferring the odd data segment in the front data part to said one of the double data rate synchronous dynamic random access memory chips;
arranging one of said at least another of the buffer memory chips for transferring the even data segment in the back data part to said another of the double data rate synchronous dynamic random access memory chips; and
arranging another of said at least another of the buffer memory chips for transferring the odd data segment in the back data part to said another of the double data rate synchronous dynamic random access memory chips.

10. The method of claim 9, wherein the N frames include a current frame and two previous frames, said method further comprising:
arranging two different ones of the buffer memory chips for separately reading the front data in the previous frames from said one of the double data rate synchronous dynamic random access memory chips; and
arranging another two different ones of the buffer memory chips for separately reading the back data in the previous frames from said another of the double data rate synchronous dynamic random access memory chips.

11. The method of claim 10, further comprising:
arranging a further group of buffer memory chips for transferring the front and back data parts in the current frame, bypassing the double data rate synchronous dynamic random access memory chips.

12. A method for transferring image data from an image data source to a source driver providing the image data to a display panel, wherein the image data is stored in the image data sources in N frames, said N frames comprising a current frame and (N−1) previous frames, each of the N frame having a data size of n bit, said method comprising:
providing P memory chips for reading or writing the frame data in a line period;
separating each of the P memory chips into (N−1) parts so that each part is used to read a portion of frame data in a different one of the (N−1) previous frames and one part is used to write a portion of frame data in the current frame, wherein each of the P memory chips has a memory space of m bits, and wherein P is an integer greater than or equal to N multiplied by (n/m); and
transferring the frame data in N frames to the source driver.

13. The method of claim 12, wherein n is substantially equal to 66 Mbits and m is substantially equal to 128 Mbits.

14. The method of claim 12, wherein
N=3 and the frame data in each frame is separable into an odd channel and an even channel, each channel having a plurality of row addresses, the row addresses comprising a first section and a second section; and wherein
P=2 and the P memory chips comprise a first double data rate synchronous dynamic random access memory (DDR_SDRAM) chip and a second DDR_SDRAM chip, wherein
the first DDR_SDRAM chip is separated into a first part and a second part, the first part for reading or writing frame data in the first section of the row addresses in the odd channel and the second part for reading or writing frame data in the second section of the row addresses in the odd channel, and
the second DDR_SDRAM chip is separated into a first part and a second part, the first part for reading or writing frame data in the first section of the row addresses in the even channel and the second part for reading or writing frame data in the second section of the row addresses in the even channel.

15. The method of claim 14, wherein the current frame comprises frame data Gn, and the previous frames comprise frame data Gn-1 and frame data Gn-2, and wherein the line period is divided into a first sub-period, a second sub-period and a last sub-period, and the reading or writing of frame data is arranged such that
the frame data Gn-2 is read in the first sub-period;
the frame data Gn-1 is read in the second sub-period; and
the frame data Gn is written in the last sub-period.

16. A timing control module for transferring image data to a display panel, wherein the image data is arranged for transferring in N frames, said control module comprising:
P memory chips for reading or writing the frame data in a line period, wherein each of the P memory chips is separated into (N−1) parts so that each part is used to read a portion of frame data in a different one of the (N−1) previous frames and one part is used to write a portion of frame data in the current frame, and wherein each of N frames has a data size of n bits and each of the P memory chips has a memory space of m bits, and wherein P is an integer greater than or equal to N multiplied by (n/m).

17. The timing control module of claim 16, wherein the line period is partitioned into N line period segments, so that the reading of the portion of the frame data in each different one of the (N−1) previous frames and writing of the portion of frame data in the current frame are carried out in different line period segments.

18. The timing control module of claim 17, wherein the memory chips comprise double data rate synchronous dynamic random access memory chips.

19. The timing control module of claim 18, further comprising:
a plurality of buffer memory chips for storing the frame data in a data transfer clock rate, and the double data rate synchronous dynamic random access memory chips are running at a clock rate substantially equal to 1.5 times the data transfer clock rate of the buffer memory chips.

20. The timing control module of claim 18, wherein N=3 and P=2, and wherein the frame data comprises a front data part and a back data part, said timing control module further comprising:
a plurality of buffer memory chips, wherein
at least one of the buffer memory chips is arranged for transferring the front data part to one of the double data rate synchronous dynamic random access memory chips; and
at least another of the buffer memory chips is arranged for transferring the back data part to another of the double data rate synchronous dynamic random access memory chips.

21. The timing control module of claim 20, wherein each of the front data part and the back data part comprises an odd data segment and an even data segment, and wherein
said at least one of the buffer memory chips comprises one memory chip for transferring the even data segment in the front data part to said one of the double data rate synchronous dynamic random access memory chips, and another memory chip for transferring the odd data segment in the front data part to said one of the double data rate synchronous dynamic random access memory chips; and
said at least another of the buffer memory chips comprises one memory chip for transferring the even data segment in the back data part to said another of the double data rate synchronous dynamic random access memory chips, and another memory chip for transferring the odd data segment in the back data part to said another of the double data rate synchronous dynamic random access memory chips.

22. The timing control module of claim 21, wherein the N frames include a current frame and two previous frames, said timing control module further comprising:
two different ones of the buffer memory chips for separately reading the front data part in the previous frames from said one of the double data rate synchronous dynamic random access memory chips; and
another two different ones of the buffer memory chips for separately reading the back data part in the previous frames from said another of the double data rate synchronous dynamic random access memory chips.

23. The timing control module of claim 22, further comprising:
a further group of buffer memory chips for transferring the front and back data parts in the current frame, bypassing the double data rate synchronous dynamic random access memory chips.

24. The timing control module of claim 23, further comprising:
a comparator for receiving
the front data part in the previous frames from said two different ones of the buffer memory chips,
the back data part in the previous frames from said another two different ones of the buffer memory chips, and
the front and back data parts in the current frame from said further group of buffer memory chips for transferring the front and back data parts in the current frame.
